(19) United States
(12) Patent Application Publication
(10) Pub. No.: US 2021/0377262 A1
(43) Pub. Date: Dec. 2, 2021

(54) Multi-Factor Authentication Based On Biological Signals Emitted By A User

(71) Applicant: Bank of America Corporation, Charlotte, NC (US)

(72) Inventors: Racquel Butler, Charlotte, NC (US); Jasmine Quintana, Charlotte, NC (US); Vicky Kivuti, Huntersville, NC (US); Chiamaka Azih, Charlotte, NC (US); Son B. Huynh, Charlotte, NC (US); Adam King, Fort Mill, SC (US); Juan Mejia, Charlotte, NC (US); Micah Langford, Charlotte, NC (US); Michael J. Sbandi, Charlotte, NC (US)

(21) Appl. No.: 16/873,692

(22) Filed: Jun. 1, 2020

(51) Int. Cl. H04L 29/06; H04L 9/32; G06F 21/45; G06N 20/00

(52) U.S. Cl. CPC H04L 63/0861; H04L 9/3236; G06F 21/45; H04L 2463/082; G06N 20/00; G06F 2221/2113; H04L 63/102

(57) ABSTRACT

Aspects of the disclosure relate to multi-factor authentication based on biological signals. A computing platform may detect an indication to authenticate a user of the user device. Subsequently, the computing platform may trigger, based on the detecting, the at least one physical sensor to capture one or more biological signals emitted by the user. Then, the computing platform may transform each of the one or more captured biological signals to binary valued data. Then, the computing platform may generate, based on the binary valued data, a security credential associated with the user. Subsequently, the computing platform may retrieve, from a database, a stored security credential. Then, the computing platform may compare the generated security credential with the stored security credential. Subsequently, the computing platform may, based on a determination that the generated security credential is within a threshold of the stored security credential, authenticate the user of the user device.

### BACKGROUND

Aspects of the disclosure relate to deploying digital data processing systems, providing information security, and detecting unauthorized access to resources of enterprise systems. In particular, one or more aspects of the disclosure relate to multi-factor authentication based on biological signals emitted by a user.

Enterprise organizations may utilize various computing infrastructure to transact business with their customers. Such transactions may include confidential information and/or other sensitive data that is created and/or used for various purposes. In some instances, such business transaction events may attempt to access customer information (e.g., confidential information and/or other sensitive data that is created, transmitted, and/or used for various purposes) over various networks and/or between various computer systems. In order to detect potentially unauthorized activities when such business is transacted, enterprise organizations may utilize various resources to authenticate enterprise users. Such authentication may be time-sensitive and may need to be performed in real-time. Ensuring that enterprise users are authenticated in a timely manner, and such authentication is performed seamlessly via user devices, may be highly advantageous to detection of potentially unauthorized activities. In many instances, however, it may be difficult to ensure authenticity of users or devices associated with an activity while also attempting to optimize the resource utilization, bandwidth utilization, and efficient operations of the computing infrastructure involved in maintaining, accessing, and executing the activity.

### SUMMARY

Aspects of the disclosure provide effective, efficient, scalable, fast, reliable, and convenient technical solutions that address and overcome the technical problems associated with secure authentication of users of enterprise resources.

In accordance with one or more embodiments, a computing platform having at least one processor communicatively coupled to a user device, at least one physical sensor communicatively coupled to the at least one processor, and memory, may detect an indication to authenticate a user of the user device. Subsequently, the computing platform may trigger, based on the detecting, the at least one physical sensor to capture one or more biological signals emitted by the user. Then, the computing platform may transform each of the captured one or more biological signals to binary valued data. Then, the computing platform may generate, based on the binary valued data, a security credential associated with the user. Subsequently, the computing platform may retrieve, from a database, a stored security credential. Then, the computing platform may compare the generated security credential with the stored security credential. Subsequently, the computing platform may, based on a determination that the generated security credential is within a threshold of the stored security credential, authenticate the user of the user device.

In some embodiments, the one or more biological signals emitted by the user may include biophotons, and the at least one physical sensor may include a camera.

In some embodiments, the one or more biological signals emitted by the user may include infrared radiation, and the at least one physical sensor may include a heat detector.

In some embodiments, the one or more biological signals emitted by the user may include a radiation signature, and the at least one physical sensor may include a radiation signature detector.

In some embodiments, the one or more biological signals emitted by the user may include myofascial sounds, and the at least one physical sensor may include a microphone.

In some embodiments, the one or more biological signals emitted by the user may include biomagnetic signals, and the at least one physical sensor may include a superconducting quantum interference device.

In some embodiments, the computing platform may generate the security credential by generating a hashed version of the generated security credential. Then, the computing platform may transmit the hashed version to a central server.

In some embodiments, the computing platform may transmit a hashed version of the generated security credential to a central server, where the comparing may include comparing, at the central server, the hashed version of the generated security credential to a hashed version of the stored security credential.

In some embodiments, the computing platform may store, in the database and for each of the one or more captured biological signals, the generated security credential.

In some embodiments, the computing platform may train a machine learning model to perform the comparing.

In some embodiments, the computing platform may train a machine learning model to generate the security credential.

In some embodiments, the computing platform may detect an attempt, via the user device, to access a secure enterprise resource. Then, the computing platform may determine a level of security associated with the secure enterprise resource. Subsequently, the computing platform may generate the security credential based on a combination of two or more of the captured one or more biological signals, where the combination is based on the level of the security.

In some embodiments, the computing platform may capture, at predetermined time periods, the one or more biological signals. Then, the computing platform may update, at the predetermined time periods, the security credential.

In some embodiments, the at least one physical sensor may be configurable to receive a signal associated with one or more of: a fingerprint of the user, a voice of the user, a retinal scan of the user, an electrothermal activity of the user, and a respiratory activity of the user.

In some embodiments, the computing platform may detect an attempt, via the user device, to access a service at a point of sales. Subsequently, the computing platform may approve or deny the access based on the generated security credential.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for managing enterprise security based on biological authentication;

FIGS. 2A and 2B depict an illustrative event sequence for managing enterprise security based on biological authentication;

FIG. 3 depicts an illustrative method for managing enterprise security based on biological authentication; and

FIG. 4 depicts another illustrative method for managing enterprise security based on biological authentication.

FIG. 5 depicts another illustrative method for managing enterprise security based on biological authentication.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Enterprise users (e.g., employees of an enterprise organization, such as a financial institution) generally have access to confidential and sensitive information associated with the enterprise organization and/or customers of the enterprise organization. An enterprise organization has a duty and a responsibility to protect such information. In many instances, confidential and secure information may be vulnerable to unauthorized access and/or misappropriation. In some instances, such unauthorized access and/or misappropriation may occur via an enterprise user, and/or an enterprise device associated with an enterprise user. Accordingly, it may be of significant importance for an enterprise organization to devise ways in which to protect the integrity of an enterprise user. Fast and reliable responses to potential unauthorized activity may be of significant importance to ensuring enterprise security.

Some aspects of the disclosure relate to managing enterprise security by utilizing biological signals emitted by a user to generate security credentials that may be utilized to authenticate a user. For example, a sensor may detect one or more biological signals emitted by a user, generate security credentials, compare the generated security credentials to stored security credentials to authenticate a user, and/or to identify a potentially unauthorized activity. Fast information processing, fast data transmission rates, availability of bandwidth, and so forth may be significant factors in managing enterprise security.

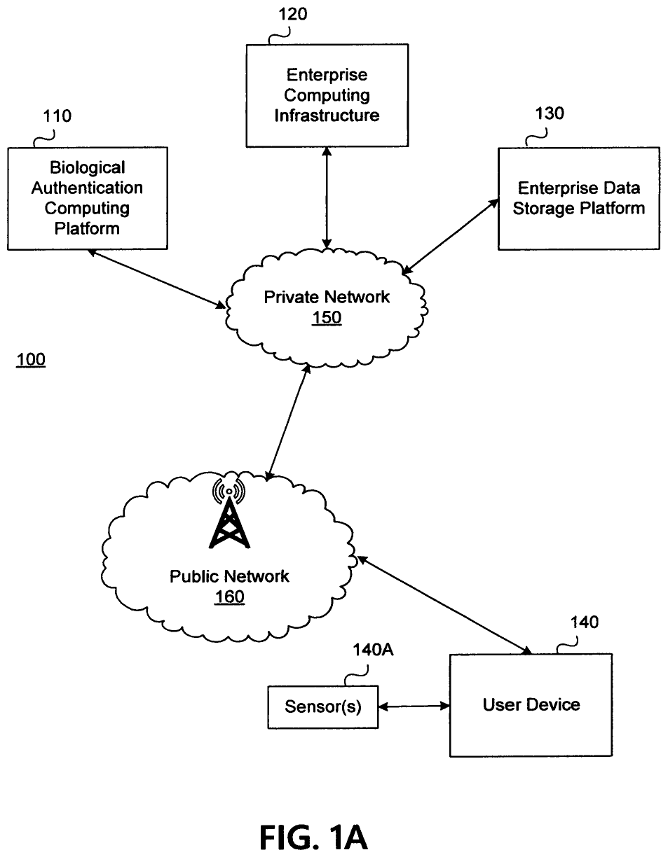

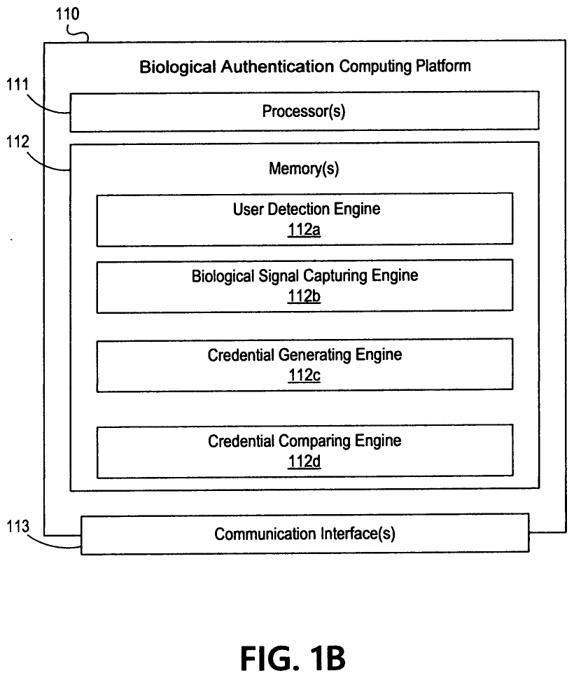

FIGS. 1A and 1B depict an illustrative computing environment for managing enterprise security based on biological authentication. Referring to FIG. 1A, computing environment 100 may include one or more computer systems. For example, computing environment 100 may include a biological authentication computing platform 110, enterprise computing infrastructure 120, an enterprise data storage platform 130, and a user device 140, communicatively coupled to a sensor 140A.

As illustrated in greater detail below, biological authentication computing platform 110 may include one or more computing devices configured to perform one or more of the functions described herein. For example, biological authentication computing platform 110 may include one or more computers (e.g., laptop computers, desktop computers, servers, server blades, or the like) and/or other computer components (e.g., processors, memories, communication interfaces).

Enterprise computing infrastructure 120 may include one or more computing devices and/or other computer components (e.g., processors, memories, communication interfaces). In addition, enterprise computing infrastructure 120 may be configured to host, execute, and/or otherwise provide one or more enterprise applications. For example, enterprise computing infrastructure 120 may be configured to host, execute, and/or otherwise provide one or more transaction processing programs, an enterprise mobile application for user devices, encryption and decryption algorithms, hash functions, and/or other programs associated with an enterprise server. In some instances, enterprise computing infrastructure 120 may be configured to provide various enterprise and/or back-office computing functions for an enterprise organization, such as a financial institution. For example, enterprise computing infrastructure 120 may include various servers and/or databases that store and/or otherwise maintain account information, such as financial account information including account balances, transaction history, account owner information, and/or other information. In addition, enterprise computing infrastructure 120 may process and/or otherwise execute tasks on specific accounts based on commands and/or other information received from other computer systems included in computing environment 100. Additionally or alternatively, enterprise computing infrastructure 120 may receive instructions from biological authentication computing platform 110 and execute the instructions in a timely manner.

Enterprise data storage platform 130 may include one or more computing devices and/or other computer components (e.g., processors, memories, communication interfaces). In addition, and as illustrated in greater detail below, enterprise data storage platform 130 may be configured to store and/or otherwise maintain enterprise data. For example, enterprise data storage platform 130 may be configured to store and/or otherwise maintain, for enterprise customers, authentication information, biometric information, and so forth. Additionally or alternatively, enterprise computing infrastructure 120 may load data from enterprise data storage platform 130, manipulate and/or otherwise process such data, and return modified data and/or other data to enterprise data storage platform 130 and/or to other computer systems included in computing environment 100.

User device 140 may be a personal computing device (e.g., desktop computer, laptop computer) or mobile computing device (e.g., smartphone, tablet, wearable device). In addition, user device 140 may be linked to and/or used by a specific user (who may, e.g., be a customer of a financial institution or other organization operating biological authentication computing platform 110). Also, for example, user of user device 140 may use user device 140 to perform transactions (e.g., perform banking operations, perform financial transactions, trade financial assets, and so forth). User device 140 may be communicatively coupled to a sensor 140A. In some embodiments, sensor 140A may be a part of user device 140 (e.g., a camera, microphone, touch sensitive screen, and so forth). In some embodiments, sensor 140A may be linked to user device 140 via a wireless, wired, and/or short-range network. For example, sensor 140A may be a standalone device capable of receiving biometric signals and/or radiation emitted by a user of user device 140. For example, sensor 140A may be a standalone camera, a smart keyboard, a smart mouse, a touchpad, and so forth, configured to perform one or more sensor functions as described herein.

Computing environment 100 also may include one or more networks, which may interconnect one or more of biological authentication computing platform 110, enterprise computing infrastructure 120, enterprise data storage platform 130, and user device 140. For example, computing environment 100 may include a private network 150 (which may, e.g., interconnect biological authentication computing platform 110, enterprise computing infrastructure 120, enterprise data storage platform 130, and/or one or more other systems which may be associated with an organization, such as a financial institution) and public network 160 (which may, e.g., interconnect user device 140 with private network 150 and/or one or more other systems, public networks, sub-networks, and/or the like). Public network 160 may be a high generation cellular network, such as, for example, a 5G or higher cellular network. In some embodiments, private network 150 may likewise be a high generation cellular enterprise network, such as, for example, a 5G or higher cellular network. In some embodiments, computing environment 100 also may include a local network (which may, e.g., interconnect user device 140 and one or more other devices with each other). For example, the local network may interconnect user device 140 with sensor 140A. Local network may be configured to send and receive data via different protocols, e.g. Bluetooth, Wireless Fidelity (“Wi-Fi”), near field communication (“NFC”), Infrared, cellular, and/or other protocols that enable device to device communication over short distances. In some embodiments, local network may be connected to public network 160.

In one or more arrangements, enterprise computing infrastructure 120, enterprise data storage platform 130, and user device 140, and/or the other systems included in computing environment 100 may be any type of computing device capable of receiving input via a user interface, and communicating the received input to one or more other computing devices. For example, enterprise computing infrastructure 120, enterprise data storage platform 130, and user device 140, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of biological authentication computing platform 110, enterprise computing infrastructure 120, enterprise data storage platform 130, and user device 140, may, in some instances, be special-purpose computing devices configured to perform specific functions.

Referring to FIG. 1B, biological authentication computing platform 110 may include one or more processors 111, memory 112, and communication interface 113. A data bus may interconnect processor 111, memory 112, and communication interface 113. Communication interface 113 may be a network interface configured to support communication between biological authentication computing platform 110 and one or more networks (e.g., network 150, network 160, a local network, or the like). Memory 112 may include one or more program modules having instructions that when executed by processor 111 cause biological authentication computing platform 110 to perform one or more functions described herein and/or one or more databases that may store and/or otherwise maintain information which may be used by such program modules and/or processor 111. In some instances, the one or more program modules and/or databases may be stored by and/or maintained in different memory units of biological authentication computing platform 110 and/or by different computing devices that may form and/or otherwise make up biological authentication computing platform 110. For example, memory 112 may have, store, and/or include a user detection engine 112a, a biological signal capturing engine 112b, a credential generating engine 112c, and a credential comparing engine 112d. User detection engine 112a may have instructions that direct and/or cause biological authentication computing platform 110 to ensure authenticity of a user and/or device that may interact with the enterprise computing infrastructure 120, as discussed in greater detail below. In some embodiments, user detection engine 112a may have instructions that direct and/or cause biological authentication computing platform 110 to detect an indication to authenticate a user of a user device; Biological signal capturing engine 112b may have instructions to trigger, based on the detecting, at least one physical sensor to capture one or more biological signals emitted by the user. Credential generating engine 112c may have instructions to transform each of the captured one or more biological signals to binary valued data. In some embodiments, credential generating engine 112c may have instructions to generate, based on the binary valued data, a security credential associated with the user. Credential comparing engine 112d may have instructions to compare the generated security credential with the stored security credential. In some embodiments, credential comparing engine 112d may have instructions to, based on a determination that the generated security credential is within a threshold of the stored security credential, authenticate the user of the user device.

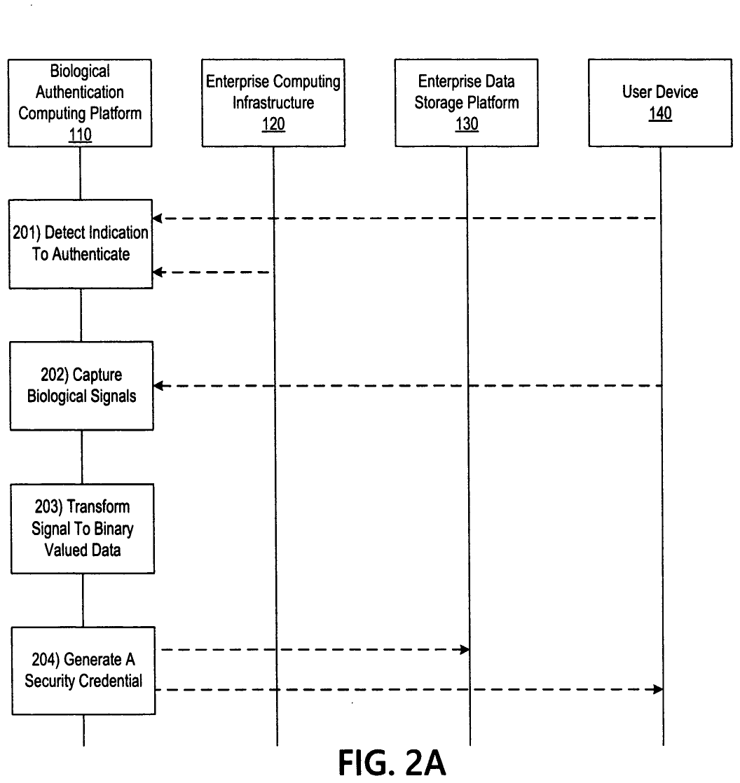

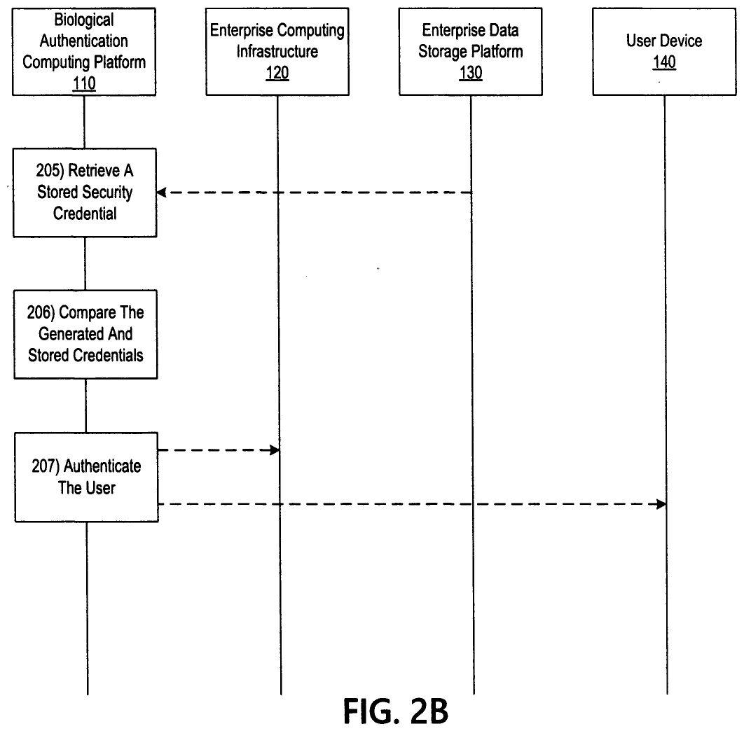

FIGS. 2A and 2B depict an illustrative event sequence for managing enterprise security based on biological authentication. Referring to FIG. 2A, at step 201, biological authentication computing platform 110 may detect, via a user device, an indication to authenticate a user of the user device. For several user activities, there may be a need for the user to be authenticated. Such authentication protects customer information from being misappropriated, complies with privacy laws, and also protects resources of an enterprise system (e.g., a financial institution) unauthorized activity. For example, a customer of the financial institution, such as for example, a banking institution, may access various enterprise resources that may be secured, and there may be a need for the user to be authenticated. For example, the user may access account information, deposit checks, transfer money, make online payments, view credit score, and/or transact other business. Generally, biological authentication computing platform 110 may detect such user activity and determine, based on the activity, that user authentication may be needed.

For example, a user of user device 140 may initiate an action to access an enterprise resource, and biological authentication computing platform 110 may detect the action. As another example, user device 140 may have an enterprise mobile application installed, and the user of user device 140 may attempt to open the mobile application to transact financial business online (e.g., deposit a check, transfer funds, pay bills, and so forth). Accordingly, biological authentication computing platform 110 may detect the attempt to open the mobile application. As another example, the user of user device 140 may be at a point-of-sales (POS) location, such as, for example, a cashier (e.g., at a grocery store, a retail store, a cafeteria, and so forth), and the user of user device 140 may attempt to make a payment using user device 140. Accordingly, biological authentication computing platform 110 may detect the attempt to make a payment.

At step 202, biological authentication computing platform 110 may trigger, based on the detecting, at least one physical sensor to capture one or more biological signals emitted by the user. As described herein, the at least one physical sensor may be a part of user device 140 (e.g., a camera, microphone, touch sensitive screen, and so forth). In some embodiments, the at least one physical sensor may be communicatively linked to user device 140 via a wireless, wired, and/or short-range network. For example, the at least one physical sensor may be a standalone device capable of receiving biometric signals and/or radiation emitted by a user of user device 140. For example, the at least one physical sensor may be a standalone camera, a smart keyboard, a smart mouse, a touchpad, and so forth, configured to perform one or more sensor functions as described herein.

Generally, the term “biological signal” may be any type of detectable biological signal of the user. For example, the biological signal may include a pulse rate, a body temperature, a glucose level, retinal movement, fingerprint data, facial recognition data, blood measure data, physiological data, and so forth. In some instances, such biological signal may be emitted by the user. Accordingly, the at least one physical sensor may be configured to capture the biological signal. For example, a microphone may capture audio signals, a camera may capture visual signals, a touch sensitive surface may capture tactile signals, and so forth. Additional and/or alternative biological signals may be captured by the at least one physical sensor.

In some embodiments, the one or more biological signals emitted by the user may include biophotons, and the at least one physical sensor may include a camera. Generally, biophotons are photons of light produced by a biological system, such as a human body. The photons of light are in the ultraviolet or low visible light range. Emission of such biophotons by the human body may be referred to as auto-luminescence. For example, finger tips of a human being may emit biophotons, and a specific color emitted may be unique to the human being. Such biophotons may be detected by photomultipliers, spectroscopes, and/or ultra-low noise charge-coupled cameras (CCD). Accordingly, the at least one physical sensor may be configured as a photomultiplier, spectroscope, and/or a CCD to detect, capture, and/or measure such biophotons.

As described herein, biological authentication computing platform 110 may identify a norm of a signal for biophotons associated with a user of user device 140. Accordingly, when an unauthorized user is present, biological authentication computing platform 110 may detect new signal for biophotons, identify a deviation from the norm for the signal for biophotons, and send a notification to and enterprise computing infrastructure (e.g., enterprise computing infrastructure 120). In some embodiments, the signal for biophotons, the identified norm, and so forth may be stored in a storage platform (e.g., enterprise data storage platform 130).

In some embodiments, the one or more biological signals emitted by the user may include thermal (e.g., infrared) radiation, and the at least one physical sensor may include a heat detector. For example, human bodies emit thermal radiation, including infrared radiation. Generally, thermal radiation is a type of electromagnetic radiation that is caused by a motion of particles in matter, such as, for example, the human body. Infrared radiation is electromagnetic radiation where wavelengths may range between 760 nanometers and 100,000 nanometers. Generally, the amount of infrared radiation depends on body temperature. For example, at a normal body temperature, the infrared radiation may comprise a wavelength of approximately 10 microns. However, the warmer a body, the more infrared radiation it may emit. In some embodiments, the thermal radiation may be detected by a camera and/or a heat detector. For example, infrared imaging capabilities of a camera associated with a mobile device may capture infrared radiation. As another example, a heat detector built into a wearable device may capture thermal radiation, including infrared radiation.

As described herein, biological authentication computing platform 110 may identify a norm of a signal for thermal radiation associated with a user of user device 140. Accordingly, when an unauthorized user is present, biological authentication computing platform 110 may detect new signal for thermal radiation, identify a deviation from the norm for the signal for thermal radiation, and send a notification to and enterprise computing infrastructure (e.g., enterprise computing infrastructure 120). In some embodiments, the signal for thermal radiation, the identified norm, and so forth may be stored in a storage platform (e.g., enterprise data storage platform 130).

In some embodiments, the one or more biological signals emitted by the user may include a radiation signature, and the at least one physical sensor may include a radiation signature detector. A human may consume various substance that may be radioactive, and such substances may be absorbed by the human body. As a result, the human body itself may emit radioactive waves. For example, a human body may include naturally occurring radionuclides. As an example, humans generally have a higher concentration of a radioactive isotope of potassium, potassium-40, may be a source of radiation from within the human body. Potassium may be ingested by the human body in various forms (e.g., bananas), and may be found in many human tissues and organs. Potassium-40 may produce gamma rays that may escape the human body. Also, for example, uranium-238, thorium-232, and so forth may be found in human bodies, and may emit radiation, although such emission is lower than the gamma radiation from potassium-40. Accordingly, the at least one physical sensor may be configured to detect, capture, and/or measure such radiation signature. Generally, an amount of emitted radiation varies with a body weight of an individual.

As described herein, biological authentication computing platform 110 may identify a norm of a signal for radiation signature associated with a user of user device 140. Accordingly, when an unauthorized user is present, biological authentication computing platform 110 may detect new signal for radiation signature, identify a deviation from the norm for the signal for radiation signature, and send a notification to and enterprise computing infrastructure (e.g., enterprise computing infrastructure 120). In some embodiments, the signal for radiation signature, the identified norm, and so forth may be stored in a storage platform (e.g., enterprise data storage platform 130).

In some embodiments, the one or more biological signals emitted by the user may include myofascial sounds, and the at least one physical sensor may include a microphone. A myofascial sound is a sound emitted by a human body in the course of daily activities. For example, myofascial tissues that support muscles in a human body may generate audio signals. Accordingly, the at least one physical sensor may be configured to detect, capture, and/or measure such myofascial sounds. For example, a microphone of a mobile device, and/or a wearable device may function as an acoustic myogram to generate a graphical representation of a velocity and/or intensity of muscular contractions.

As described herein, biological authentication computing platform 110 may identify a norm of a signal for myofascial sounds associated with a user of user device 140. Accordingly, when an unauthorized user is present, biological authentication computing platform 110 may detect new signal for myofascial sounds, identify a deviation from the norm for the signal for myofascial sounds, and send a notification to and enterprise computing infrastructure (e.g., enterprise computing infrastructure 120). In some embodiments, the signal for myofascial sounds, the identified norm, and so forth may be stored in a storage platform (e.g., enterprise data storage platform 130).

In some embodiments, the one or more biological signals emitted by the user may include biomagnetic signals, and the at least one physical sensor may include a superconducting quantum interference device. For example, a human body may generate a magnetic field, such as, for example, a field associated with electrophysiological functions of the heart, brain, nerves, and/or muscles. Generally, the magnetic field is weak, and may be measured with a magnetic sensor such as, for example, a superconducting quantum interference device (SQUID). For example, a human brain may generate a magnetic field, which may be measured by a magnetoencephalogram. Also, for example, magnetic activity from peripheral nerves may be measured by a magnetoneurogram. As another example, magnetic activity from the gastrointestinal tract may be measured by a magnetogastrogram. Also, for example, magnetic activity from the heart may be measured by a magnetocardiogram. Accordingly, the at least one physical sensor may be configured as a magnetic sensor to detect, capture, and/or measure such biomagnetic signals.

As described herein, biological authentication computing platform 110 may identify a norm for biomagnetic signals associated with a user of user device 140. Accordingly, when an unauthorized user is present, biological authentication computing platform 110 may detect new biomagnetic signals, identify a deviation from the norm for the biomagnetic signals, and send a notification to and enterprise computing infrastructure (e.g., enterprise computing infrastructure 120). In some embodiments, the biomagnetic signals, the identified norm, and so forth may be stored in a storage platform (e.g., enterprise data storage platform 130).

In some embodiments, the at least one physical sensor may be configurable to receive a signal associated with one or more of: a fingerprint of the user, a voice of the user, a retinal scan of the user, an electrothermal activity of the user, and a respiratory activity of the user. For example, the at least one physical sensor may be configurable to detect a fingerprint associated with the user. For example, fingerprint detection sensors may detect a fingerprint pattern for a user associated with user device. The physical sensor to detect a fingerprint may be an optical sensor, a capacitive sensor, an ultrasonic sensor, and/or based on any other type of fingerprint scanning technology. As described herein, biological authentication computing platform 110 may identify a norm of fingerprint data associated with a user of user device 140. Accordingly, when an unauthorized user is present, biological authentication computing platform 110 may detect new fingerprint data, identify a deviation from the norm for the fingerprint data, and send a notification to and enterprise computing infrastructure (e.g., enterprise computing infrastructure 120). In some embodiments, fingerprint data, the identified norm, and so forth may be stored in a storage platform (e.g., enterprise data storage platform 130). Additional and/or alternative biometric signals may be detected, captured, and/or measured by the at least one physical sensor.

At step 203, biological authentication computing platform 110 may transform each of the captured one or more biological signals to binary valued data. Generally, the one or more captured biological signals may be analog signals, and such analog signals may be converted to digital signals. Different types of transducers may be generally used to convert mechanical, electrical, light, thermal, acoustic, and/or electromagnetic energy to an electrical signal, which may be sampled over time to produce a digital signal. For example, a photoresistor may convert biophotons to a change in resistance, which may then be used to produce a change in current flowing in a circuit. Such current may be sampled over time to produce a digital signal, which may then be converted to binary valued data. Also, for example, myofascial sounds may be captured as an acoustic signal in an audio data file, and stored in a digital format. Likewise, image data from an image capturing device may be stored in a digital format. In some embodiments, the at least one physical sensor may be configured to have a corresponding transducer embedded into it. In some embodiments, user device 140 may be configured to have a corresponding transducer embedded into it.

At step 204, biological authentication computing platform 110 may generate, based on the binary valued data, a security credential associated with the user. For example, a user may be associated with unique signals such as, for example, corresponding to biophotons, thermal radiation, radiation signature, myofascial sounds, biomagnetic signals, fingerprint, voice, retinal scan, electrothermal activity, respiratory activity, and so forth. The binary valued data for such signals may constitute a unique digital signature associated with the user. In some embodiments, the one or more biological signals and/or the binary valued data may be processed to filter out noise, and/or otherwise purify the signal to generate the security credential associated with the user. In some embodiments, the one or more biological signals and/or the binary valued data may be normalized over time to generate the security credential associated with the user. In some embodiments, the one or more biological signals and/or the binary valued data may be captured at different times of day, different seasons, different activity levels, different geographical locations, and so forth to capture unique patterns that may constitute the generated security credential associated with the user.

Although the security credential may be transmitted over a network, in many instances, it may be preferable to transmit the security credential in a secure manner so as to maintain confidentiality of the data, as well as protect the security credential from unauthorized use. In some embodiments, biological authentication computing platform 110 may generate the security credential by generating a hashed version of the security credential. A hash function (e.g., a cryptographic hash function) may be generally used to map data of an arbitrary size to data of a fixed size. A variety of hash functions may be utilized, such as, for example, MD5, SHA-1, SHA256, SHA512, SHA-3, BLAKE2s, BLAKE2d, and so forth. In some embodiments, biological authentication computing platform 110 may transmit the hashed version to a central server (e.g., enterprise data storage platform 130).

In some embodiments, biological authentication computing platform 110 may capture, at predetermined time periods, the one or more biological signals. Then, the computing platform may update, at the predetermined time periods, the generated security credential. As described herein, one or more biological signals may be captured at different times of day, during different seasons, at different activity levels, in different geographical locations, and so forth. Also, for example, the captured signals may depend on body temperature, body weight, level of activity, and so forth. Accordingly, biological authentication computing platform 110 may capture the one or more biological signals at predetermined time periods, so as to account for variations.

In some embodiments, biological authentication computing platform 110 may train a machine learning model to generate the security credential. For example, a machine learning model may be trained to analyze variations in the one or more captured biological signals. In some embodiments, the machine learning model may be trained to detect patterns in the one or more biological signals captured at different times of day, during different seasons, at different activity levels, in different geographical locations, and so forth. Also, for example, the machine learning model may be trained to detect patterns in the captured signals based on body temperature, body weight, level of activity, and so forth. Also, for example, the machine learning model may be trained to detect patterns in interplays between the one or more biological signals. For example, the machine learning model may be trained to detect patterns between biophotons being emitted, levels of infrared radiation, radiation signatures, audio profiles based on myofascial sounds, measured biomagnetism, fingerprint data, voice data, retinal scan data, patterns of electrothermal activity, patterns of respiratory activity, and so forth. For example, a k-means clustering and/or a principal component analysis technique may be utilized to detect and classify various patterns.

In some embodiments, the machine learning model may be trained via supervised learning techniques, based on labeled data (e.g., historical data). For example, one or more of the biological signals may be validated against a retinal scan of the user. Such data may serve as trained data. Generally, biological authentication computing platform 110 may be configured to apply supervised learning techniques based on one or more of random forest, gradient boosted trees, support vector machines, neural networks, decision trees, and so forth. In some embodiments, the one or more biological signals (e.g., image data) may include unstructured data. Accordingly, the machine learning model may be trained via a combination of supervised and semi-supervised learning techniques. For example, biological authentication computing platform 110 may be configured to apply a supervised learning technique in combination with a clustering and/or dimensional reduction technique. For example, a k-means clustering and/or a principal component analysis technique may be utilized.

Generally, for each type of biological signal, biological authentication computing platform 110 may generate several baseline security credentials, based on, for example, the one or more factors described herein. In some embodiments, biological authentication computing platform 110 may apply the trained machine learning model to generate the security credential. For example, the machine learning model may recognize a time of day, and generate a baseline security credential based on a plurality of biological signals captured at that time of the day. authenticates the user based on the determination of the time of the day. As another example, the machine learning model may detect an outside temperature, and generate a baseline security credential based on a plurality of biological signals captured at or about that outside temperature. Also, for example, the machine learning model may detect that a user has been physically active (e.g., working out, walking, jogging, etc.), and generate a baseline security credential based on a plurality of biological signals captured at or about that level of activity.

In some embodiments, an aggregate security credential may be generated based on the baseline security credentials. For example, a weighted aggregate may be determined, where the weight applied to the baseline security credential associated with a biological signal may be determined by the machine learning model. In some embodiments, the machine learning model may dynamically adjust respective weights applied to the component baseline security credentials based on the one or more factors described herein. For example, when a body temperature is determined to be significantly different from a normal human body temperature, the baseline security credential based on infrared radiation signals may be associated with a lower weight. Also, for example, when a body weight is detected to significantly change over time, the baseline security credential based on the radiation signature may be associated with a lower weight.

In some embodiments, biological authentication computing platform 110 may store, in the database and for each of the one or more captured biological signals, the generated security credential. In some embodiments, the generated security credential may be stored in user device 140. In some embodiments, the generated security credential may be stored in a database (e.g., enterprise data storage platform 130).

Referring to FIG. 2B, at step 205, biological authentication computing platform 110 may retrieve, from a database, a stored security credential. As described herein, the generated security credential may be stored in a database. Accordingly, biological authentication computing platform 110 may retrieve the generated security credential from the database for authentication purposes.

At step 206, biological authentication computing platform 110 may compare the generated security credential with the stored security credential. For example, the stored security credential may be a baseline security credential corresponding to a specific biological signal, or an aggregate of one or more of such baseline security credentials. In some embodiments, biological authentication computing platform 110 may compare the generated security credential against an appropriate baseline security credential to determine if there are any deviations. For example, biological authentication computing platform 110 may determine if the deviation of the generated security credential from the baseline security credential exceeds a threshold. In some embodiments, the threshold may depend on the underlying biological signal, and/or one or more factors (e.g., time of day, season, level of activity, and so forth).

For example, the at least one physical sensor may be configurable to detect changes in biological signals caused by various external and internal stimuli, such as, for example, stress (e.g., mental, emotional, psychological, and so forth), aggressive behavior, fear, anxiety, and so forth. In some embodiments, biological authentication computing platform 110 may determine a baseline security credential and/or applicable threshold for such variations in the biological signals. Accordingly, if the deviation of the generated security credential from the baseline security credential exceeds the threshold, biological authentication computing platform 110 may be configurable to detect such a deviation

In some embodiments, biological authentication computing platform 110 may transmit a hashed version of the generated security credential to a central server, where the comparing may include comparing, at the central server, the hashed version of the generated security credential to a hashed version of the stored security credential. As described herein, a hashed version of a baseline security credential may be stored in a central server (e.g. enterprise data storage platform 130). In some embodiments, biological authentication computing platform 110 may transmit the hashed version of the generated security credential to the central server, and a comparison of the hashed version of the generated security credential to the hashed version of the stored security credential may be performed.

In some embodiments, biological authentication computing platform 110 may detect an attempt, via the user device, to access a secure enterprise resource. Then, biological authentication computing platform 110 may determine a level of security associated with the secure enterprise resource. Subsequently, biological authentication computing platform 110 may generate the security credential based on a combination of two or more of the captured one or more biological signals, where the combination is based on the level of the security. For example, biological authentication computing platform 110 may determine an appropriate authentication process based on an assessment of a risk level of a user activity, and/or the secure enterprise resource.

For example, a user associated with user device 140 may be at a vehicle dealership and may request authorization for a high value transaction on a credit card to pay for a down payment for purchase of the vehicle. Upon initiating use of the credit card to perform the transaction, biological authentication computing platform 110 may detect a request to authorize the event (e.g., credit card transaction). Based on an amount and a type of transaction, biological authentication computing platform 110 may determine that the event is associated with a high risk level. Accordingly, biological authentication computing platform 110 may trigger detection of a plurality of biological signals and generate a security credential based on the plurality of biological signals.

In some embodiments, each of the security credentials, associated with an underlying biological signal, may be associated with a risk level. For example, the security credentials may be ranked based on how reliable they may be for authentication purposes. Such relative ranking may change based on the one or more factors such as time of day, body weight, level of activity, and so forth. In some embodiments, each activity may be associated with a level of risk, and for each level of risk, biological authentication computing platform 110 may determine the appropriate authentication process. For example, for an activity with a low level of risk, one security credential (e.g., based on biophotons) may utilized. As another example, for an activity with a medium level of risk, two or more security credentials (e.g., based on biophotons and radiation signatures) may utilized. Also, for example, for an activity with a high level of risk, an aggregated security credential (e.g., based on biophotons, radiation signatures, myofascial sounds, and biomagnetism) may utilized. Also, for example, for an activity with a high level of risk, biological authentication computing platform 110 may trigger a real-time detection of a plurality of biological signals and generate the security credential in real-time. In other instances, such as for an activity with a low level of risk, biological authentication computing platform 110 may utilize a security credential stored in user device 140 and send a hashed version of the security credential to a central server as authentication of the user.

In some embodiments, biological authentication computing platform 110 may train a machine learning model to perform the comparing. In some embodiments, biological authentication computing platform 110 may apply the trained machine learning model to perform the comparing. For example, the machine learning model may be trained to recognize a time of day, may be trained to identify a threshold and/or stored security credential corresponding to the time of day, and biological authentication computing platform 110 may perform the comparing based on trained model. As another example, the machine learning model may be trained to detect an outside temperature, may be trained to identify a threshold and/or stored security credential corresponding to the detected outside temperature, and biological authentication computing platform 110 may perform the comparing based on such factors. Also, for example, the machine learning model may be trained to detect that a user has been physically active (e.g., working out, walking, jogging, etc.), may be trained to identify a threshold and/or stored security credential corresponding to the detected level of activity, and biological authentication computing platform 110 may perform the comparing based on such factors.

At step 207, biological authentication computing platform 110 may, based on a determination that the generated security credential is within a threshold of the stored security credential, authenticate the user of the user device. For example, user of user device 140 may attempt to access their account information, and biological authentication computing platform 110 may, based on a determination that the generated security credential is within a threshold of the stored security credential, authenticate the user and enable access to the account information. As another example, user of user device 140 may attempt to submit an application for a mortgage via user device 140, and biological authentication computing platform 110 may, based on a determination that the generated security credential is within a threshold of the stored security credential, authenticate the user and validate submission of the application. Also, for example, user of user device 140 may attempt to place a trading request via a trading platform on user device 140, and biological authentication computing platform 110 may, based on a determination that the generated security credential is within a threshold of the stored security credential, authenticate the user and validate the trading request.

In some embodiments, biological authentication computing platform 110 may detect an attempt, via the user device, to access a service at a point of sales (POS). Subsequently, biological authentication computing platform 110 may approve or deny the access based on the generated security credential. For example, user of user device 140 may attempt to make a payment at a POS (e.g., a cashier at a checkout counter in a store) via user device 140, and biological authentication computing platform 110 may, based on a determination that the generated security credential is within a threshold of the stored security credential, authenticate the user, and may approve the payment transaction. In some embodiments, based on a determination that the generated security credential is not within a threshold of the stored security credential, biological authentication computing platform 110 may not authenticate the user, and may deny the payment transaction

In some embodiments, based on a determination that the generated security credential is not within a threshold of the stored security credential, biological authentication computing platform 110 may initiate one or more remediation tasks. For example, when a transaction is being processed, in response to a discrepancy between the generated security credential and the stored security credential, biological authentication computing platform 110 may deny the transaction, and send a notification to a user associated with an account that was used for the transaction. In some embodiments, biological authentication computing platform 110 may send a notification to security personnel associated with a financial institution associated with the transaction.

For example, if the discrepancy is large (e.g., outside a threshold range of a statistical norm), biological authentication computing platform 110 may automatically initiate the one or more remediation tasks. For example, biological authentication computing platform 110 may automatically log out an enterprise user from a mobile application, and prompt the enterprise user to re-authenticate (e.g., login again, provide fingerprint data, capture one or more biological signals, and so forth). Also, for example, biological authentication computing platform 110 may automatically restrict access to enterprise resources, access to a network, access to a computing device, and so forth.

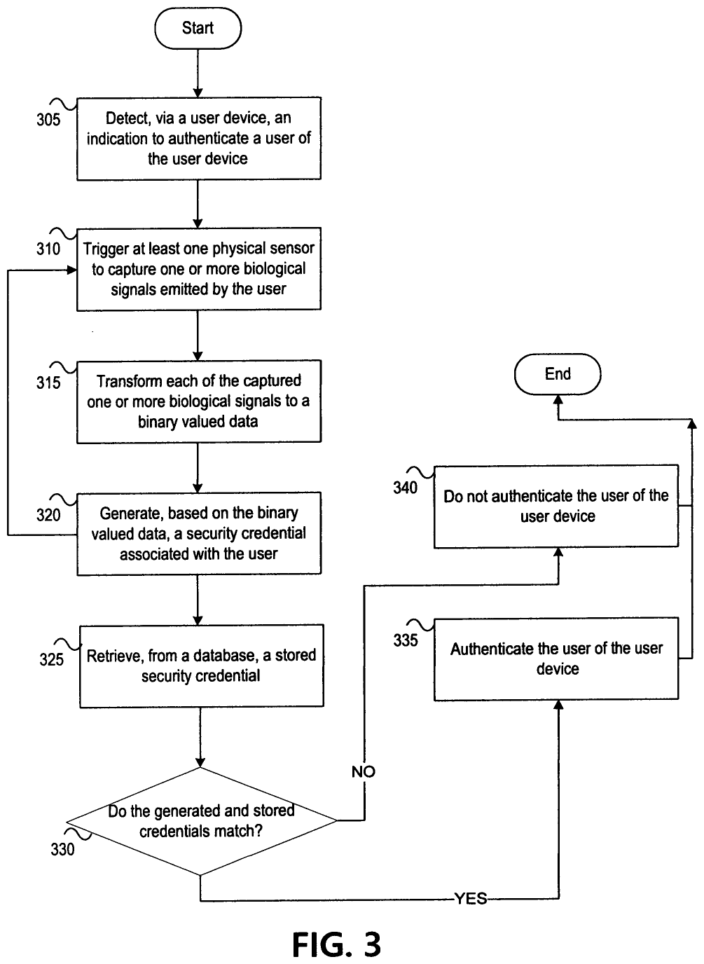

FIG. 3 depicts an illustrative method for managing enterprise security based on biological authentication. Referring to FIG. 3, at step 305, a computing platform having at least one processor communicatively coupled to a user device, at least one physical sensor communicatively coupled to the at least one processor, and memory may detect, via the user device, an indication to authenticate a user of the user device. At step 310, the computing platform may trigger, based on the detecting, the at least one physical sensor to capture one or more biological signals emitted by the user. At step 315, the computing platform may transform each of the captured one or more biological signals to binary valued data. At step 320, the computing platform may generate, based on the binary valued data, a security credential associated with the user. In some embodiments, the process may return to step 305 to detect another indication to authenticate the user. In some embodiments, the process may proceed to step 325. At step 325, the computing platform may retrieve, from a database, a stored security credential.

At step 330, the computing platform may compare the generated security credential with the stored security credential. Upon a determination that the generated security credential is within a threshold of the stored security credential, the process may proceed to step 335. At step 335, the computing platform may authenticate the user of the user device. Upon a determination that the generated security credential is not within a threshold of the stored security credential, the process may proceed to step 340. At step 340, the computing platform may not authenticate the user of the user device.

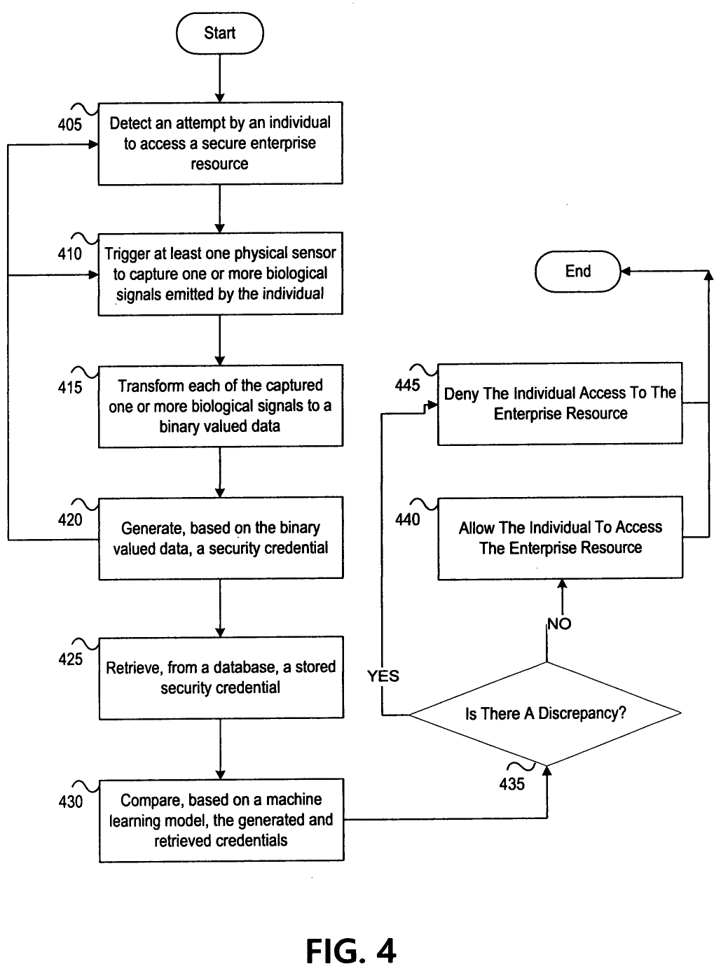

FIG. 4 depicts another illustrative method for managing enterprise security based on biological authentication. Referring to FIG. 4, at step 405, a computing platform having at least one processor, at least one physical sensor communicatively coupled to the at least one processor, and memory may detect an attempt by an individual to access a secure enterprise resource. At step 410, the computing platform may trigger, based on the detecting, the at least one physical sensor to capture one or more biological signals emitted by the individual. At step 415, the computing platform may transform each of the captured one or more biological signals to binary valued data. At step 420, the computing platform may generate, based on the binary valued data, a security credential. In some embodiments, the process may return to step 405 to detect another attempt by the individual to access another secure enterprise resource. In some embodiments, the process may return to step 410 to trigger the at least one physical sensor to capture another biological signal.

In some embodiments, the process may proceed to step 425. At step 425, the computing platform may retrieve, from a database, a stored security credential. At step 430, the computing platform may compare, by applying a machine learning model, the generated security credential with the stored security credential.

At step 435, the computing platform may determine if there is a discrepancy between the generated security credential and the stored security credential. Upon a determination that there is no discrepancy between the generated security credential and the stored security credential, the process may proceed to step 440. At step 440, the computing platform may allow the individual access to the secure enterprise resource. Upon a determination that there is a discrepancy between the generated security credential and the stored security credential, the process may proceed to step 445. At step 445, the computing platform may deny the individual access to the secure enterprise resource.

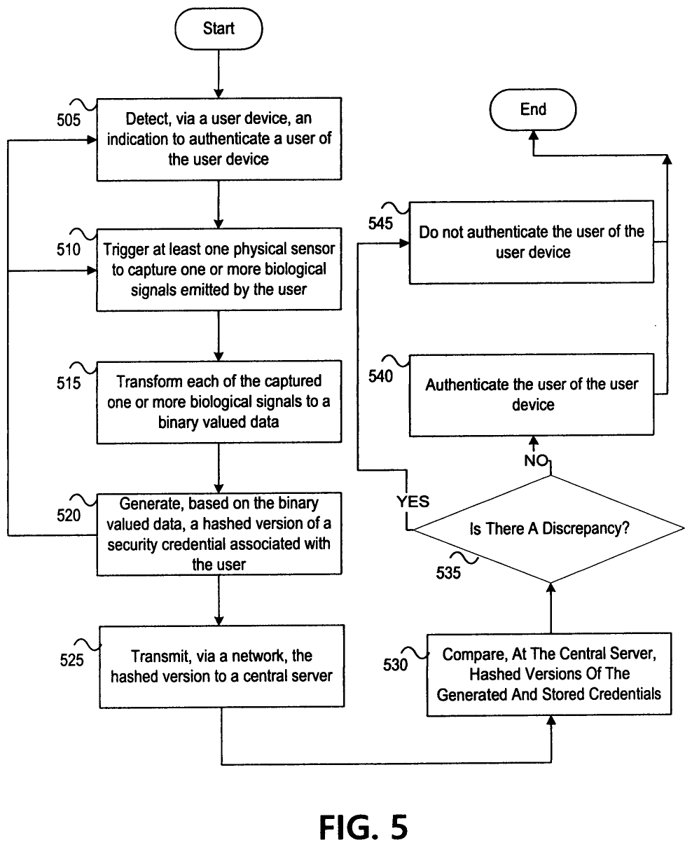

FIG. 5 depicts another illustrative method for managing enterprise security based on biological authentication. Referring to FIG. 5, at step 505, a computing platform having at least one processor, at least one physical sensor communicatively coupled to the at least one processor, and memory may detect, via a user device, an indication to authenticate a user of the user device. At step 510, the computing platform may trigger, based on the detecting, the at least one physical sensor to capture one or more biological signals emitted by the user. At step 515, the computing platform may transform each of the captured one or more biological signals to binary valued data. At step 520, the computing platform may generate, based on the binary valued data, a hashed version of a security credential associated with the user. In some embodiments, the process may return to step 505 to detect another indication to authenticate the user. In some embodiments, the process may return to step 510 to trigger the at least one physical sensor to capture another biological signal. In some embodiments, the process may proceed to step 525. At step 525, the computing platform may transmit, via a network, the hashed version to a central server. At step 530, the computing platform may compare, at the central server, the hashed version of the generated security credential with a hashed version of a stored security credential.

At step 535, the computing platform may determine if there is a discrepancy between the hashed version of the generated security credential and the hashed version of the stored security credential. Upon a determination that the hashed version of the generated security credential is within a threshold of the hashed version of the stored security credential, the process may proceed to step 540. At step 540, the computing platform may authenticate the user of the user device. Upon a determination that the hashed version of the generated security credential is not within a threshold of the hashed version of the stored security credential, the process may proceed to step 545. At step 545, the computing platform may not authenticate the user of the user device.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular time-sensitive tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor communicatively coupled to a user device;
at least one physical sensor communicatively coupled to the at least one processor; and
memory storing computer-readable instructions that, when executed by the at least one processor, cause the computing platform to:
detect, via the user device, an indication to authenticate a user of the user device;
trigger, based on the detecting, the at least one physical sensor to capture one or more biological signals emitted by the user;
transform each of the captured one or more biological signals to binary valued data;
generate, based on the binary valued data, a security credential associated with the user;
retrieve, from a database, a stored security credential;
compare the generated security credential with the stored security credential; and
based on a determination that the generated security credential is within a threshold of the stored security credential, authenticate the user of the user device.

2. The computing platform of claim 1, wherein the one or more biological signals emitted by the user comprises biophotons, and the at least one physical sensor comprises a camera.

3. The computing platform of claim 1, wherein the one or more biological signals emitted by the user comprises infrared radiation, and the at least one physical sensor comprises a camera or a heat detector.

4. The computing platform of claim 1, wherein the one or more biological signals emitted by the user comprises a radiation signature, and the at least one physical sensor comprises a radiation signature detector.

5. The computing platform of claim 1, wherein the one or more biological signals emitted by the user comprises myofascial sounds, and the at least one physical sensor comprises a microphone.

6. The computing platform of claim 1, wherein the one or more biological signals emitted by the user comprises biomagnetic signals, and the at least one physical sensor comprises a superconducting quantum interference device.

7. The computing platform of claim 1, wherein the instructions comprise additional computer-readable instructions that, when executed by the at least one processor, cause the computing platform to:
generate the security credential by generating a hashed version of the generated security credential; and
transmit the hashed version to a central server.

8. The computing platform of claim 1, wherein the instructions comprise additional computer-readable instructions that, when executed by the at least one processor, cause the computing platform to:
transmit a hashed version of the generated security credential to a central server, and
wherein the comparing comprises comparing, at the central server, the hashed version of the generated security credential to a hashed version of the stored security credential.

9. The computing platform of claim 1, wherein the instructions comprise additional computer-readable instructions that, when executed by the at least one processor, cause the computing platform to:
store, in the database and for each of the one or more captured biological signals, the generated security credential.

10. The computing platform of claim 1, wherein the instructions comprise additional computer-readable instructions that, when executed by the at least one processor, cause the computing platform to:
train a machine learning model to perform the comparing.

11. The computing platform of claim 1, wherein the instructions comprise additional computer-readable instructions that, when executed by the at least one processor, cause the computing platform to:
train a machine learning model to generate the security credential.

12. The computing platform of claim 1, wherein the instructions comprise additional computer-readable instructions that, when executed by the at least one processor, cause the computing platform to:
detect an attempt, via the user device, to access a secure enterprise resource;
determine a level of security associated with the secure enterprise resource; and
generate the security credential based on a combination of two or more of the one or more captured biological signals, wherein the combination is based on the level of the security.

13. The computing platform of claim 1, wherein the instructions comprise additional computer-readable instructions that, when executed by the at least one processor, cause the computing platform to:
capture, at predetermined time periods, the one or more biological signals; and
update, at the predetermined time periods, the security credential.

14. The computing platform of claim 1, wherein the at least one physical sensor is configurable to receive a signal associated with one or more of: a fingerprint of the user, a voice of the user, a retinal scan of the user, an electrothermal activity of the user, and a respiratory activity of the user.

15. The computing platform of claim 1, wherein the instructions comprise additional computer-readable instructions that, when executed by the at least one processor, cause the computing platform to:
detect an attempt, via the user device, to access a service at a point of sales; and
approve or deny the access based on the generated security credential.

16. A method, comprising:
at a computing platform comprising at least one processor, at least one physical sensor communicatively coupled to the at least one processor, and memory:
detecting an attempt by an individual to access a secure enterprise resource;
triggering, based on the detecting, the at least one physical sensor to capture one or more biological signals emitted by the individual;
transforming each of the captured one or more biological signals to binary valued data;
generating, based on the binary valued data, a security credential;
retrieving, from a database, a stored security credential;
comparing, by applying a machine learning model, the generated security credential with the stored security credential;
based on a determination that the generated security credential is within a threshold of the stored security credential, authenticating a user of the user device; and
enabling, based on the authenticating, the individual to access the secure enterprise resource.

17. The method of claim 16, wherein the one or more biological signals emitted by the individual comprises biophotons, infrared radiation, radiation, myofascial sounds, and biomagnetic signals.

18. The method of claim 16, further comprising:
generating the security credential from a previously captured biological signal emitted by the user; and
storing, in a database, the security credential.

19. The method of claim 18, further comprising:
training a machine learning model to perform the generating of the security credential.

20. One or more non-transitory computer-readable media storing instructions that, when executed by a computing platform comprising at least one processor, at least one physical sensor communicatively coupled to the at least one processor, and memory, cause the computing platform to:
detect, via a user device, an indication to authenticate a user of the user device;
trigger, based on the detecting, the at least one physical sensor to capture one or more biological signals emitted by the user;
transform each of the captured one or more biological signals to binary valued data;
generate, based on the binary valued data, a hashed version of a security credential associated with the user;
transmit, via a network, the hashed version to a central server;
compare, at the central server, the hashed version of the generated security credential with a hashed version of a stored security credential; and
based on a determination that the hashed version of the generated security credential is within a threshold of the hashed version of a stored security credential, authenticate the user of the user device.
